(19) United States
(12) Patent Application Publication
(10) Pub. No.: US 2013/0293886 A1
(43) Pub. Date: Nov. 7, 2013

(54) Flange for Closing Off an Optical Device Against a Sample Stream, and an Optical Device for Partial Immersion in a Sample Stream

(71) Applicants: Nico Correns, Weimar (DE); Marion Sobe, Weimar (DE)

(72) Inventors: Nico Correns, Weimar (DE); Marion Sobe, Weimar (DE)

(73) Assignee: CARL ZEISS MICROSCOPY GMBH, Jena (DE)

(21) Appl. No.: 13/820,196

(22) PCT Filed: Aug. 26, 2011
(86) PCT No.: PCT/EP11/64715

§ 371 Date: Mar. 1, 2013

(30) Foreign Application Priority Data
Sep. 29, 2010 (DE) 10 2010 047 103.8

(51) Int. Cl. G01J 3/28

(52) U.S. Cl. CPC G01J 3/28
USPC 356/326; 137/559

(57) ABSTRACT

In an arrangement to optically illuminate and/or to perform measurements in a sample stream through a flange which is arranged in the sample stream and closes off a hollow space against the sample stream, there is a continuous loss of material due to abrasion of wall particles, and the flange therefore has to be exchanged on a regular basis. The invention has the purpose of reducing the wear on the flange. To meet this objective, a part of the wall extending along a closed loop around the hollow space (3) consists of an elastomeric body (2.3). This concept makes it possible for the flange or at least for a part of the flange to elastically back away under a concentrated load. Thus, the rate of abrasion of the wall by the sample stream is reduced, because a large part of the incoming energy is converted to heat in the elastomeric body.

The invention concerns a flange for closing off an optical device against a stream of sample substance, wherein the flange has a wall which includes a window and which at least partially encloses a hollow space, wherein the window includes an at least partially transparent window panel.

The sample stream, as the term is to be understood in the context of the invention, can either be a stream of test material (“test material stream”) that is to be optically investigated or a stream of material that is to be optically irradiated (“irradiation material stream”) or a combined test- and irradiation material stream. The material stream is typically a stream of pourable bulk material, but it can also be a stream composed of discrete pieces of material. The sample stream can be a diverted portion of a main stream, but normally this is the case only with test material streams. After the measurement with the optical device, the diverted sample stream can be merged back into the main stream. Alternatively, the sample stream can be discarded after the measurement. However, a measurement and/or irradiation can also take place in the main stream, so that the sample stream is constituted by the main stream itself.

The window in the sense of the present invention is an opening in the wall, containing a window panel and constituting a part of the wall. In the following, the term “wall” is therefore meant to include the window unless explicitly stated otherwise. The window panel can be transparent over its entire area or only over part of the area filled by the window and/or it can be transparent over the entire spectrum or only over a part of the spectrum.

The term “light” as used hereinafter includes, besides visible electromagnetic radiation, also the ranges of infrared and ultraviolet radiation to the extent that they can be controlled by optical means.

The present state of the art offers a variety of optical measuring devices for the non-destructive investigation of object materials. Measuring devices of this kind find application, inter alia, in agriculture for the classification of harvested goods and in the food industry for the characterization and monitoring of raw materials. It is likewise state-of-the-art knowledge to irradiate objects without performing an optical measurement. For example, drinking water is irradiated with UV light in order to kill microbes which could be present in the water.

When optical devices are used to perform an irradiation and/or a measurement of a sample stream, it is always necessary to protect the internal elements of the device, for example the light source and/or the optical sensor, against contact with the sample stream, in order to avoid the risk of contaminating or even damaging the internal elements. Normally, it is also necessary to protect the sample stream from contact with the interior of the device, for example in order to avoid contamination or losses. The interior of the device is therefore separated from the sample or the sample stream by a flange that includes a wall with a window. The accumulation of a deposit layer on the window can be avoided by using a wear-resistant material for the window panel and installing the window or the entire device at an angle so as to deflect the incident sample stream by a few degrees. Thus, the incoming stream of material arriving for measurement and/or irradiation will always dislodge the preceding material from the window and push it on. As a result, the window is simultaneously cleaned, so that the optical device is kept fit for operation.

For example in U.S. Pat. No. 6,421,990 B1 and in WO 2006/035012 A1,spectroscopic measuring devices for agricultural harvesting machines are described. They include a light source which, during operation, irradiates a sample steam, in particular a stream of harvested produce, by sending light through a window. The light that is reflected back behind the window from the sample material is then diverted into different, wavelength-dependent directions by a spectrometer using a dispersive element, for example a diffraction grating or a prism. The different wavelengths of the spectrally sorted light, which are in the visible or near infrared range, are received by detector elements occupying different locations of an optoelectronic sensor array. With this spatial/spectral sorting allocation to different detector elements, measured intensity values are assigned to discrete segments of the spectral range received by the sensor array. The output signals of the detector elements are sent to a processor which, based on the spectral measurements, calculates certain parameters of the sample stream.

The impact of the sample stream causes a continuous loss of material due to abrasion of particles from the wall of the flange, despite the use of wear-resistant materials such as for example sapphire for the window panel and steel for the rest of the wall, so that the flange has to be exchanged on a regular basis. This represents an important cost factor, as the measuring device has to be taken out of the sample stream and at least partially disassembled, which necessitates an interruption of the measurement and normally also of the sample stream. Consequently, production may temporarily come to a halt.

It is therefore the object of the invention to improve a flange of the general kind defined hereinabove with the aim of a reduced wear rate.

This task is solved with a flange possessing the features specified in claim 1.

Advantageous further developed aspects of the invention are described in the subordinate claims.

According to the inventive concept, the wall (outside the area of the window) along a closed loop encircling the hollow space consists of an elastomeric body. An elastomeric body in the sense of the invention is a body consisting entirely or at least principally of a work material or auxiliary material exhibiting the properties of an elastomer in particular in the temperature range between −40° C. and +70° C. Advantageously, the elastomeric body can encircle a surface normal of the window and/or an optical axis of the optical device which passes through the window. The elastomeric body can also be referred to as an elastic coupling member or an elastic element with a (significantly) lower modulus of elasticity than the window. The wall outside the area of the window can be formed of one integral piece, so that it consists exclusively of the elastomeric body. According to the invention, the elastomeric body in this case has a (significantly) lower modulus of elasticity than the window. The wall outside the area of the window can be formed of a plurality of parts, so that the elastomeric body occupies only the area along the closed loop. According to the invention, the elastomeric body in this case has a (significantly) lower modulus of elasticity than at least one of the other wall parts. Preferably, the elastomeric body has a (significantly) lower modulus of elasticity than all of the other wall parts.

An elastomeric body has the property of being reversibly deformable over a large range of deformation amplitudes. The conventional rigid connection within the flange, between the surface area facing towards the measuring instrument and the surface area exposed to the object material to be measured, is thereby eliminated. The invention makes it possible for the flange, or at least for a part of the flange and in particular for the window, to elastically back away under a concentrated load. Thus, the amount of material being eroded from the surface of the window and from the rest of the wall by the sample stream is reduced, because a large part of the incoming energy is converted to heat in the elastomeric body. As an advantageous result, wear of the flange is significantly reduced and its service life is extended. In addition, the risk of a sudden destructive failure is lessened. After the load has passed, the flange can return to its original position in a damped rebound.

As a practical arrangement, the wall is essentially configured as a tube which is closed off at least at one end, wherein the window is arranged at the closed end, and wherein the cross-section varies between different parts of the tube. This allows the flange to be inserted into an opening while the optical device can remain outside the opening. The attribute “closed-off” in this context means that the flange is sealed tight against the sample stream. In particular, it can be sealed tight against liquids, specifically water, or even gas-tight, especially air-tight. It is also possible to close the flange tube at both ends. In this case it is necessary to either arrange a window at both ends in order to let light pass through the flange to the optical device, or an optoelectronic detector has to be arranged in the interior of the tube. In the latter case, further optical elements can be arranged in the interior of the tube, for example a diffraction slit and/or dispersion elements such as a diffraction grating or a prism.

Advantageously, the elastomeric body is configured—particularly in regard to its stiffness—in such a way that when the window is attacked by a physical force (from impacts and strikes of particles of the sample stream), at least a part of the wall, including the window in particular embodiments, will reversibly back away. As a result of this, in connection with the damping effect of the elastomeric body, the linear momentum imparted to the measuring instrument by the incident sample stream is thereby lessened, which reduces the mechanical burden (strong impact absorption). The backing-away can occur parallel and/or perpendicular to a longitudinal axis of the tube. If the window or the entire flange is arranged in a tilted position in the sample stream, which is advantageous for the cleaning of the window, the largest force components occur in the axial direction of the tube, so that a backing-away in this direction provides a maximum of wear reduction.

Preferably, a stiffness property of the elastomeric body exhibits a non-linear dependency on a deformation amplitude (elongation, compression). This applies to the directions parallel and/or perpendicular to the longitudinal axis of the tube. The stiffness preferably increases exponentially with increasing deformation amplitude. Excessive deformation amplitudes are thereby prevented. The window is normally configured either as a planar-parallel plate or as an optical lens. As long as the displacements of the window are small, the resultant optical image error will be negligible. Consequently, the non-linear stiffness lessens the risk of radiation- and/or measurement inaccuracies.

Advantageously, the elastomeric body can have the form of an adhesive seam. This can be of particular advantage in embodiments of the flange which include a frame holding the window, wherein the frame is connected by way of a bead of adhesive compound to a base part which is not arranged in the sample stream and which, in turn, serves for the connection to the optical device. Alternatively, the base part can be constituted by the housing of the measuring device. In a further embodiment in which an elastomeric adhesive seam is advantageous, the window is frameless and in direct contact with the elastomeric adhesive seam, connected by way of the latter to the basic body. Through the formation of an elastomeric adhesive seam, the space required for the flange can be reduced. An elastomeric adhesive seam can consist for example of a soft elastomer adhesive such as a silicone adhesive. Brittle hard adhesives are not suitable.

Particularly preferred according to the invention are flanges that include a vibration damper. With a conventional rigid flange, the impacts of hard particles that are contained in the sample stream as well as possible vibrations generated by the impacts are transmitted to the entire optical device and in particular to the interior of the optical device. Such mechanical stress loads can affect the measurement accuracy and the service life of instrument components. With the use of vibration-damping, the potential energy of a reversible deflection of the elastomeric body is converted into internal energy and thereby dissipated within a very short time. Resonance effects are thereby avoided. In addition, the propagation of the shock into the optical device is significantly reduced and its stress exposure to the shocks and vibrations originating from the sample stream is reduced. Normally, the elastomeric body itself acts as a vibration damper. Thus, no additional component is needed to perform the damping function.

In another embodiment, the elastomeric body is substituted by elastically resilient elements and separate vibration damping elements and the hollow space is closed off against the outside space in the vicinity of the resilient elements by means of a barrier element such as a foil or a bellows. This solution has the same benefits as the embodiment with an elastomeric body but requires more space and is clearly more expensive than the solution according to the invention.

In advantageous embodiments, the elastomeric body encloses a fluid. This allows a reduction in stiffness of the elastomeric body and in particular a strong damping of vibrations. With a suitable arrangement of flow channels for the fluid inside the elastomeric body, it is possible to set on the one hand the dynamic damping characteristics and on the other hand the elastic behavior as a function of displacement. An example of an elastomeric body with flow channels of this kind is found in U.S. Pat. No. 4,765,601.

According to a first way of realizing this concept, a non-elastomeric body holds, more specifically frames, the window and is connected to the elastomeric body, in particular through an adhesive connection, a clamp connection or a vulcanized connection. A non-elastomeric supporting body or frame prevents the window from changing its angle under an uneven distribution of the forces exerted by the sample stream.

According to a second variant, the elastomeric body holds or frames the window, in particular by means of a non-elastomeric back-up ring. This embodiment can be realized without the need for an expensive non-elastomeric support body.

Further embodiments are possible which are different from the foregoing two variants.

Advantageously, the wall in the area outside of the window can consist within at least 80% of its volume, in particular within at least 90%, and more specifically within at least 95% of its volume, of the elastomeric body. In particular, it can include a non-elastomeric back-up ring to hold the window and/or non-elastomeric bushings for the attachment of fastener elements, particularly in an arrangement where the bushings are vulcanized into the collar. This concept can be realized largely without the need for expensive non-elastomeric wall parts.

In further developed embodiments, the window can consist of a plurality of layers with different degrees of hardness, in particular with a hardness that increases in the direction towards the sample stream, in particular with a diamond coating on the outside. In connection with the property of the window backing away due to the elastomeric body, the so-called eggshell effect which occurs in laminated windows with large differences in hardness between the layers can advantageously be avoided. A diamond-coated sapphire window is particularly preferred.

The wall in areas outside the window preferably consists of a plurality of connected bodies with different degrees of hardness, in particular with a graduated increase in hardness towards the side of the sample stream. Thus, only the outside surfaces that are in contact with the sample stream have to be made of an expensive hardened material. For the substructure, a low-cost material such as mild steel can be used.

The flange advantageously includes provisions to even out air pressure fluctuations occurring in the hollow space as a result of elastic deformation of the elastomeric body, as disclosed for example in WO 02/082153 A1. This has the purpose of preventing the penetration of dirt into the interior of the flange.

The flange preferably includes a collar serving to support the flange on an outside wall of a sample stream conduit, in particular to fasten the flange to the outside wall.

Advantageously, the flange according to the invention consists of an elastomeric body in which non-elastomeric bushings are arranged which serve to receive fastener elements, wherein the bushings are in particular vulcanized into the collar.

Optionally, a non-elastomeric back-up ring may be provided as a mount for the window.

In a flange according to the invention, the frame of the window can be integrally formed in a pipe for the transport of the sample stream. The pipe is in this case considered to be part of the flange.

The invention also includes an optical device with a flange serving to illuminate a sample stream through the window and/or to receive light from a sample stream through the window. The device can in particular be a spectrometer for measurements of the spectrum of light that enters through the window into the hollow space. The flange can be connected releasably or non-releasably with a housing of the device. It can in particular be formed integrally in one piece with the housing of the device. In the sense of the invention, the light received into the hollow space includes light that is scattered and/or emitted by the sample.

The invention further encompasses an optical device with a housing and a flange which at least partially encloses a hollow space, wherein the flange has a window and the flange is at least partially arranged in the opening of a pipe, so that a sample stream flowing in the pipe can be illuminated through the window and/or that light from a sample stream flowing in the pipe window can be received through the window, in particular by a spectrometer serving to measure the spectral distribution of light entering through the window into the hollow space, including an elastomeric body for the connection of the housing to the pipe, in particular to support the housing on the pipe. With the elastomeric body, the housing and thus the entire optical device is uncoupled from shocks and vibrations occurring in the pipe. The service life of the optical device can thereby be extended significantly. Preferably, bushings are included in the connecting elastomeric body, for example vulcanized into the latter, whereby the elastomeric body can be connected on the one hand to the pipe and on the other hand to the housing by way of fastener elements such as screws. Advantageously, the optical device is connected to the pipe exclusively by way of the elastomeric body. The flange can additionally be configured with an elastomeric body of its own as described above.

The optical devices can include separate windows for the illumination and for receiving the incoming light.

The invention encompasses in particular an agricultural machine with an optical device having a flange according to the invention, wherein the flange of the optical device is arranged in particular in an opening of a pipe that serves to transport a sample stream. The pipe can for example be a tank discharge pipe of a harvester combine or evacuation chimney of a forage harvester, through which the harvested materials are ejected.

In all of the variants, the flange can be connected to the optical device by way of a base part, wherein the base part itself is preferably not arranged in the sample stream. As the optical window is separated from the base part of the flange by the elastomeric body, a less expensive material can be used for the base part than for a conventional continuous wall. At the same time, materials with a high wear resistance can be used for the wall parts that are exposed to the sample stream and for the window panel, for example high-hardness metal alloys, ceramics and the like for the wall.

In all embodiments, non-elastomeric wall components such as the window or the supporting body can be connected to the elastomeric body by adhesive bonding or clamping or a non-elastomeric wall component can be vulcanized into the elastomeric body. In the case of a metallic mount for the window and a metallic base part, the bond can for example be constituted by a vulcanized rubber-to-metal connection.

In the following, the invention is explained in more detail through examples of embodiments which are illustrated in the drawings, wherein:

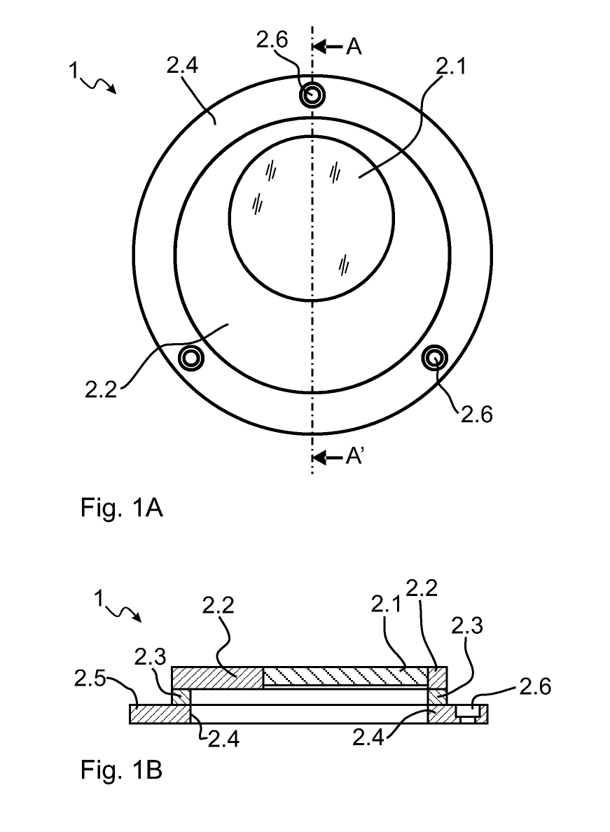

FIG. 1 shows a first flange for an optical device in a top view and in cross-section;

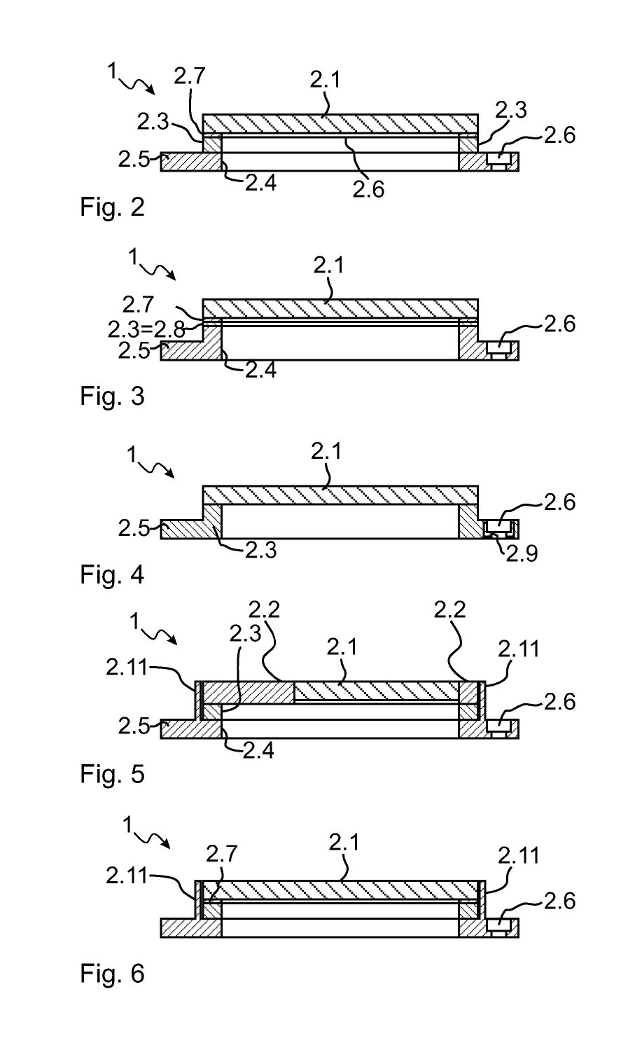

FIG. 2 shows the first flange in cross-section;

FIG. 3 shows a second flange in cross-section;

FIG. 4 shows a third flange in cross-section;

FIG. 5 shows a fourth flange in cross-section;

FIG. 6 shows a fifth flange in cross-section;

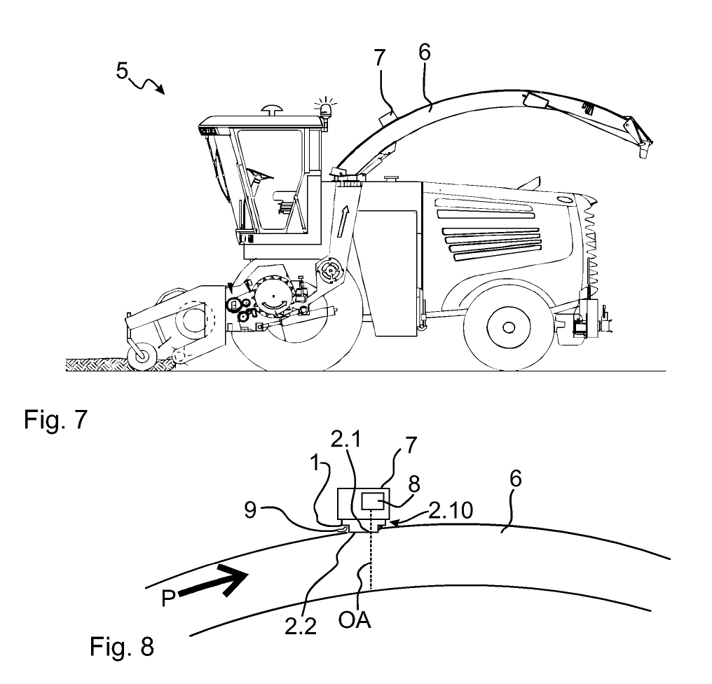

FIG. 7 shows an agricultural machine with an optical measuring device in side view; and

FIG. 8 shows a detail of the discharge chimney of the agricultural machine with the measuring device in side view.

Elements that are identical from one drawing to another carry the same reference symbols.

FIG. 1 in the two different views 1A and 1B shows a flange 1 with a wall 2, wherein the latter includes a window 2.1, a frame 2.2 for the window, an elastomeric body 2.3, and a base part 2.4. FIG. 1B represents a cross-section in a plane which is indicated by the dash-dotted line A-A′ in FIG. 1A. The tubular-shaped wall 2 partially encloses a hollow space 3. The window 2.1 consists for example of (transparent) sapphire; the frame 2.2 and the base part 2.4 consist for example of non-hardened high-grade stainless steel. Alternatively, the base part 2.4 can consist of a lower-grade material, for example mild steel, particularly if the base part is not exposed to the sample stream. The elastomeric body 2.3, constituting a part of the wall 2, encircles the hollow space in a closed loop and consists for example of rubber. In the illustrated example, the elastomeric body 2.3 has the shape of a hollow cylinder. However, instead of the circular profile, the elastomeric body in different embodiments could have an internal and/or external profile in the shape of an elliptical ring or a polygon. The base part 2.4 includes for example a collar 2.5 and recessed mounting holes 2.6, through which fastener elements, for example screw bolts (not shown) can be inserted.

The flange 1 is designed to be rigidly connected to a housing of an optical device (not shown in this drawing) and has the purpose to close off the latter against a sample stream (not shown). It is also possible that the housing itself is already fully enclosed and has a window of its own, in front of which the flange can be mounted by means of the recessed mounting holes 2.6. Due to the reversibly deformable elastomeric body 2.3 which at the same time acts as a vibration damper, there is no rigid connection between the frame 2.2 with the window 2.1 on one side and the base part 2.4 on the other side.

The elastomeric body 2.3 is connected on one side to the frame 2.2 and on the other side to the base part 2.4, for example by way of a rubber-to-metal bond produced by vulcanization. In alternative embodiments, the elastic element can be clamped or glued to form the respective connections to the two wall components 2.2 and 2.4. The connections are configured so that they will be able to withstand tensile, compressive, and shear stresses which arise from the contact with the anticipated sample stream (not shown in the drawing).

In FIG. 2, a frameless flange 1 is shown in cross-sectional view. The window 2.1 is supported by a back-up ring 2.7, consisting for example of high-grade steel, to which the window is adhesively bonded. The back-up ring has the purpose of backing the window over a large continuous surface area in order to avoid excessive localized stresses in the window material under a concentrated point load. The back-up ring 2.7 is connected to a vibration-damping elastic body 2.3, for example vulcanized into the latter. Analogous to FIG. 1, the elastic body 2.3 is connected to a base part 2.4.

In the flange 1 shown in FIG. 3, the elastomeric body 2.3 is configured as an adhesive seam 2.8 which connects the back-up ring 2.7 to the base part 2.4. The appropriately dimensioned adhesive seam 2.8 simultaneously performs the functions of a connection and of a vibration-damping elastic element.

FIG. 4 represents a flange 1 in which the entire wall 2 with the exception of the window 2.1 consists of the elastomeric body 2.3. Bushings 2.9 with recessed fastening holes 2.6 are vulcanized into the collar 2.5.

FIG. 5 represents a flange 1 analogous to FIG. 1, wherein the base part 2.4 includes a circumferential shield 2.11 for the protection of the elastomeric body 2.3.

FIG. 6 represents a flange 1 according to FIG. 2, wherein the base part 2.4 likewise includes a circumferential shield 2.11 for the protection of the elastomeric body 2.3.

FIG. 7 represents an agricultural machine 5 in the form of a forage harvester. Processed harvested material can be discharged through a pipe 6 which is referred to as chimney. As a means to determine the quality of the harvested material, an optical measuring instrument 7 in the form of a spectrometer (not shown) is mounted in an opening of the pipe 6. The measuring instrument includes a flange 1 in accordance with the invention, for example according to one of the preceding drawing figures, wherein the flange projects into the sample stream (which is in this case identical to the main stream). In order to achieve the desired vibration-damping, the housing of the measuring instrument 7 is connected to the pipe 6 only by way of an elastomeric body 9 which is arranged in a closed loop around the circumference of the flange 1.

FIG. 8 shows in an enlarged detail view the pipe 6 through which the sample stream P is transported. As an example, up to five tons of sample material per minute are sent past the flange 1 with the optical window 2.1 at a speed of up to 55 m/sec. The measuring device 7 including the housing with the rigidly connected flange 1 and, accordingly, the window 2.1 are installed in the pipe 6 in such a way that the flange 1, due to its position and orientation, deflects the sample stream P by a small angle of a few degrees. Incoming sample material from upstream pushes the material ahead of it. At the same time, the window is being cleaned. A light source (not shown) for the illumination of the sample stream P through the window 2.1 and a spectrometer 8 are arranged inside the measuring device 7. The optical axis of the spectrometer 8 is directed through the window 2.1 of the flange 1 into the pipe 1 in order to measure the spectral composition of light that is scattered out of the sample stream P. A pressure equalization valve 2.10 is arranged in the hollow space 3, whereby volume changes that occur when the window 2.1 elastically backs away from the sample stream P are balanced out. In an alternative embodiment, the frame 2.2 of the window 2.1 can be formed integrally with the pipe 6.

The window in all embodiments can be designed as a multi-layered laminate, which allows an optimal adaptation to specified requirements regarding optical properties, mechanical strength, and wear resistance.

In all embodiments, the required values for the modulus of elasticity and for the hardness as well as the geometric shape of the elastic element are to be determined in accordance with the specified maximally permissible movement of the window in the optical light path and the maximally permissible mechanical load exerted by the sample mass stream on the wall including the window. The geometric shape of the elastomeric body can be varied in two dimensions. It can also be given an asymmetric shape.

The elasticity of the elastomeric body is preferably set to a level were an average thrust exerted on the flange causes only a small deformation of the elastomeric body, for example no more than 1/10 mm to 1 mm, and that a deformation of more than 1 mm occurs only under hard impacts or shocks by heavy chunks in the sample stream.

The invention can be employed for example in the transportation, incoming and outgoing quality control, and processing of plant- or animal-based, chemical and pharmaceutical goods and construction waste. The optical device according to the invention can be used in feedback control loops for mixing devices used to merge a first mass flow stream with a second mass flow stream or to monitor the manual addition of substances to a mass flow stream. The optical device according to the invention can in particular be installed on pipe conduits carrying a material stream into and/or out of forage silos and grain storage containers. It can be used to monitor the cleaning of transport pipes, wherein a transport pipe is rinsed repeatedly with a constant quantity of solvent for a contaminant, until the concentration of the contaminant in the solvent as determined by means of the measuring device is close to constant. In this procedure, the same quantity of solvent can be used in each rinsing cycle, or fresh solvent can be used each time.

### LIST OF REFERENCE SYMBOLS

1 flange
2 wall
2.1 window
2.2 frame
2.3 elastomeric body
2.4 base part
2.5 collar
2.6 recessed hole
2.7 back-up ring
2.8 adhesive seam
2.9 bushing
2.10 pressure equalization valve
2.11 shield
3 hollow space
4 bushing
5 agricultural machine
6 pipe
7 optical device
8 spectrometer
9 elastomeric connector body
P sample stream
OA optical axis

1-18. (canceled)

19. A flange, comprising:
a wall including a window,
wherein:
the wall at least partially encloses a hollow space;
the window comprises an at least partially transparent window panel;
a part of the wall along a closed loop extends around the hollow space; and
the part of the wall comprises an elastomeric body.

20. The flange of claim 19, wherein the wall is essentially tubular, an end of the wall is closed, and the window is arranged in the closed end of the wall.

21. The flange of claim 20, wherein the tube has different cross-sectional profiles at different locations of the wall.

22. The flange of claim 20, wherein the elastomeric body is configured so that, when the window is subjected to a force component directed parallel to a longitudinal axis of the wall, a portion of the wall yields to the force by reversibly backing away.

23. The flange of claim 22, wherein the portion of the wall includes the window.

24. The flange of claim 19, wherein a rigidity of the elastomeric body exhibits a non-linear dependent relationship to an amount of deformation.

25. The flange of claim 19, wherein the elastomeric body comprises an adhesive seam.

26. The flange of claim 19, wherein the flange comprises a vibration damper.

27. The flange of claim 19, wherein the elastomeric body encloses a fluid.

28. The flange of claim 19, comprising a non-elastomeric body supporting the window, wherein the non-elastomeric body is connected to the elastomeric body.

29. The flange of claim 19, wherein the elastomeric body supports or frames the window.

30. The flange of claim 19, wherein the elastomeric body comprises at least 80% of a volume of the wall outside an area of the window.

31. The flange of claim 19, wherein the window comprises a plurality of layers of different degrees of hardness, and wherein the window carries a diamond coating on the outside.

32. The flange of claim 19, wherein the wall in the areas outside the window comprises a plurality of bodies connected to each other, and the plurality of bodies have different degrees of hardness.

33. The flange of claim 19, further comprising a mechanism to compensate for air pressure fluctuations inside the hollow space which occur when the elastomeric body is elastically deformed.

34. The flange of claim 19, further comprising a collar configured to support the flange on an exterior wall of a sample stream conduit.

35. An optical instrument, comprising:
a flange according to claim 1, the flange being configured to illuminate a sample stream through the window and/or configured to receive light from the sample stream through the window; and
a spectrometer configured to measure a spectral composition of light entering the hollow space through the window.

36. An optical device, comprising:
a housing;
a flange at least partially enclosing a hollow space, the flange comprising a window; and
a spectrometer,
wherein:
the optical device is configured so that, when the flange is at least partially in an opening of a pipe, a sample stream in the pipe is illuminated through the window and/or light is received from the sample stream through the window;
the spectrometer is configured to measure a spectral composition of light entering the hollow space through the window; and
the optical device comprises an elastomeric body configured to connect the housing to the pipe.

37. A machine, comprising:
a pipe to transport a sample stream; and
an optical device according to 35,
wherein the flange of the optical device is arranged in an opening of the pipe, and the machine is an agricultural machine.

38. A machine, comprising:
a pipe to transport a sample stream; and
an optical device according to 36,
wherein the flange of the optical device is arranged in an opening of the pipe, and the machine is an agricultural machine.
